(19) United States
(12) Patent Application Publication
(10) Pub. No.: US 2004/0114157 A1
(43) Pub. Date: Jun. 17, 2004

(54) System for calibrating digital color printers

(75) Inventors: Stephen F. Linder, Fairport, NY (US); Yingjun Bai, Webster, NY (US); Peter D. McCandlish, Pittsford, NY (US)

Correspondence Address: Patent Documentation Center, Xerox Corporation, 20th Floor, Xerox Square, 100 Clinton Ave. S., Rochester, NY, 14644, US

(73) Assignee: Xerox Corporation

(21) Appl. No.: 10/317,230

(22) Filed: Dec. 11, 2002

(51) Int. Cl. H04N 1/50

(52) U.S. Cl. 358/1.9; 358/504

(57) ABSTRACT

A digital printer outputs a set of test sheets for a calibration operation. Each test sheet bears metadata identifying the test sheet with regard to the calibration operation and the printer which outputted it. The test sheets are fed into a color scanner having a document handler, where downstream software coordinates the scanning operation to yield calibration data for each printer identified on the test sheets. Test sheets from a plurality of printers can be scanned through a document handler, facilitating automatic calibration of a fleet of printers. A network utility can be used to select printers to be calibrated in the fleet of printers.

### TECHNICAL FIELD

The present invention relates to the calibration of digital printers (a definition which includes copiers and multifunction devices), by which test image data is sent to a printer, causing the printer to output test images which can be recorded and analyzed. Data derived from the analysis is used to adjust the printer for image quality.

### BACKGROUND

A digital printing apparatus, commonly of a xerographic “laser” type or a solid or liquid ink-jet type, receives digitized image data from a source computer or input scanner and processes the data to operate hardware within the printer, such as a modulating laser discharging areas on a charge receptor or ejectors in a moving ink-jet printhead, so that a desired image based on the input data is rendered on a print sheet.

In the ordinary use of any digital printer, it is desired to adjust certain parameters of the printer to obtain a desired appearance of output prints; in the case of operating a plurality of printers, it would be desirable to have all of the printers produce substantially identical output, particularly in regard to subtle color renderings. Also, the performance of a printer will drift over time, as a result of, for example, the machine heating up with use, changing temperature or humidity conditions around the machine, marking material (such as toner or liquid ink) aging within the machine, or marking material being replaced. For these reasons, it is known to periodically “calibrate” a digital printer.

In the basic calibration method for color printers, an output sheet or sheets, typically including test patches based on desired colors, is output from a target printer and then tested for color rendering accuracy using a scanner, spectrophotometer, or other color measuring device. In one embodiment, the RGB values originating from the scanner are processed to yield estimated device independent color values, which are used to generate the updated image path parameters, such as tone response curves and look-up tables, that are used to calibrate the printer. Any detected differences between the actual colors output on the sheets and the desired color outputs are noted and then used to alter the behavior of the printer in subsequent prints.

Recently, with practical improvements in the image quality related to input scanners used in, for example, digital copiers, an input scanner itself can be used as a reliable color measuring device for calibration purposes. In other words, an output sheet of test patches can be fed through a scanner which is free-standing or available on a digital copier, and the necessary test data can be derived readily by software in effect installed in the digital copier or scanner. This test data can then be used to calibrate a target printer over a network, or the printer which is resident within the digital copier having the scanner.

### DESCRIPTION OF THE PRIOR ART

U.S. Pat. Nos. 5,432,112; 5,537,516; 5,612,902; 5,739,927; and 6,185,004 include descriptions of calibration processes in the context of digital printers and copiers.

U.S. Pat. No. 6,048,117 discloses using a digital scanner as a color measuring device for test images on sheets output by various printers.

In the prior art, it is known to submit sheets having test images thereon to a scanner portion of a digital scanner. However, the process is not automated, and typically involves close interaction through a user interface to identify each mode that requires calibration; such requirements make submission of multiple test image sheets through a document handler impossible.

### SUMMARY OF THE INVENTION

According to one aspect of the invention, there is provided a method of calibrating a digital printer. The digital printer is caused output a plurality of test sheets, each test sheet bearing a subset of test images and metadata identifying the subset of test images relative to a set of test images used for a calibration operation.

According to another aspect of the invention, there is provided a method of calibrating a plurality of digital printers. Information about when the digital printer was last calibrated is obtained from each of the plurality of digital printers. A selected subset of the plurality of digital printers is caused to output a sheet bearing a test image.

### BRIEF DESCRIPTION OF THE DRAWINGS

FIG. 1 is a diagram showing a set of printers, copiers, and scanners interconnected over a network.

FIG. 2 is an example of a test sheet generated by a printer.

FIG. 3 is a flowchart showing a method of processing data derived from a test patch image.

FIG. 4 is an example screen as would appear in a network utility for calibrating a plurality of printers on a network.

### DETAILED DESCRIPTION

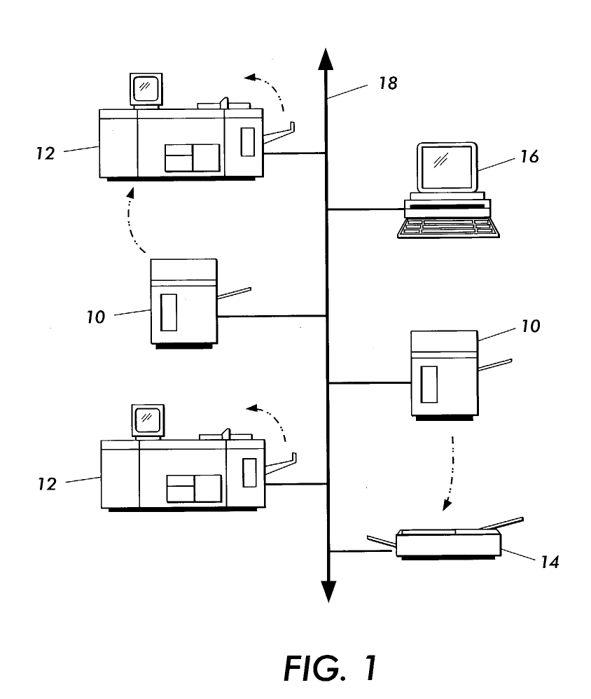

FIG. 1 is a diagram showing a set of printers, copiers, and scanners interconnected over a network. The printers are each generally indicated as 10; the copiers, 12 (in a digital context, it is common that a digital copier can function as a printer as well; for this reason a “copier” or other multifunction device shall be considered a type of “printer” for present purposes); and a scanner is shown as 14. As is well known in any office context, there are also on the network any number of computers 16, each computer being either a source of image data for the printers or copiers and/or having administrative functions over one or more machines. One or more computers can act as a server for implementing the network 18 through which all of the machines communicate. Of course, the machines such as shown in the Figure need not be located in one small area, but can be distributed anywhere in the world, and can include machines which are associated with end users, system administrators, and service providers. The scanner 14 is shown as a standard scanner for documents, but in an embodiment, the scanner could be in the form of a dedicated spectrophotometer, suitably connected to the network 18, as well. It is common that a scanner associated with a copier such as 12 will have associated therewith an automatic document handler, for the feeding of a series of sheets for recording by the scanner.

As mentioned above, any printer such as 10, as well as printers resident inside copiers 12, will occasionally or periodically need calibration. Calibration will require the printer or copier to output one or more test sheets, each test sheet bearing one or more test patches. The image data for rendering the test patches can originate within each printer or copier, or come from a computer 16 on the network 18. Calibration further requires that the output test sheets be scrutinized by a color measuring device; an input scanner, such as free-standing scanner 14 or a scanner associated with a copier 12, and which is ordinarily adapted for scanning of documents, can be used for this purpose.

As described, for example, in U.S. Pat. No. 5,739,927, a thorough color calibration process may require up to 1000 test patches to be generated by a printer and then scanned in by a scanner for processing. It is difficult for the requisite number of test patches, each of an adequate size, to be placed on a single test sheet: it would be preferable if the test patches could be spread over a set or plurality of test sheets for each calibration process. Since most middle-to-high-volume copiers and scanners include a document handler, the set of test sheets can readily be loaded into and fed through the document handler for rapid feeding and recording of the test sheet images for calibration purposes.

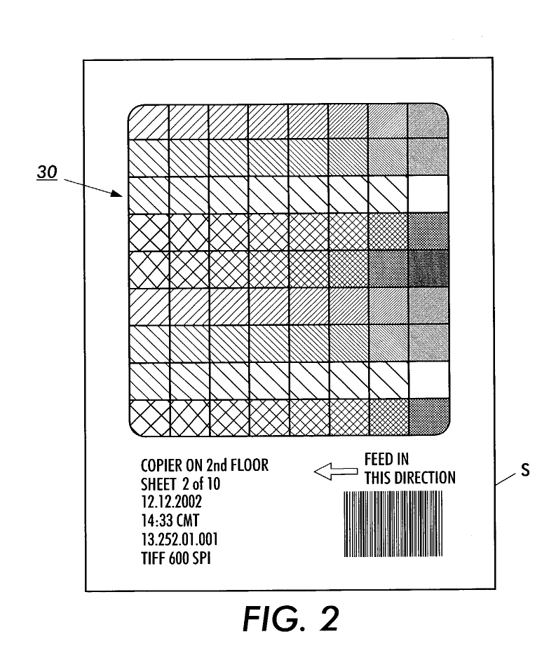

FIG. 2 is an example of a test image on a test sheet generated by a printer, according to one embodiment. Such a test sheet would be one of a set of test sheets used in a single calibration operation: for example, if the calibration operation for a printer requires printing and reading 1000 test patches, ten test sheets bearing 100 patches each are output by the printer, and these ten sheets are loaded into the document handler of a digital copier 12 or scanner 14 for recording. In addition, a device may have a number of different modes that need to be calibrated. Each mode would require one or more additional sheets.

In this embodiment, a test image on one test sheet S includes any number of test patches, forming a subset of test patches, here shown as 30, required for a calibration operation. More broadly, the test sheet can include any kind of “test images,” meaning not only test patches but other types of images to test, for example, image skew, multi-image registration, orientation, etc. Also as shown, a test sheet may include an arrow to indicate to a user the direction in which to feed the sheet through a documents handler. Of course, the method can be applied to any kind of testing for monochrome printing as well. Any such method in which an output print is monitored and such monitoring can result in an adjustment to subsequent behavior of the printer can for present purposes be considered “calibration.”

Further, the test image includes what is generally called metadata, relating to identifying aspects of the particular test image on the sheet. As shown in the embodiment, metadata includes data relating to the identity (such as the network address or alias) of the printer, or printer portion of a copier, being calibrated; the time at which the test sheet was printed; and a code identifying the subset of test patches on the test sheet relative to the entire set of test sheets needed for the complete calibration operation (e.g., “Sheet 2 of 10”).

The metadata can also include an identification of a “mode” of a calibration operation to be carried out. As used herein, a mode is identification of an aspect of a rendering system, such as a page description language or other format and resolution, which determines the nature of the test images. Typical modes include TIFF at 600 spi (spots per inch); TIFF at 300 spi; Adobe® PostScript® at 600 spi; and so forth. Very specialized calibration operations, such as for custom or corporate colors, can be identified by mode as well. Typically, each mode to be calibrated for is dedicated to one or more sheets of the set of test images; the present embodiment thus facilitates calibration of a selected one mode, or any number of modes, simply by selecting which test sheets to print or submit to a scanner.

The metadata can be borne on the test sheet in one or more of a number of ways: for example, by a machine-readable bar code, a “glyph” code such as PARC™ DataGlyphs®, and/or alphanumeric characters which can be read through an optical character recognition (OCR) system associated with the scanner. The specific metadata to be placed on any test sheet, such as the printer name or network address, or the time of printing the test sheet, is usually readily available in the context of network printing. In a simple embodiment, such as where there are only two test sheets required for a desired calibration operation, the metadata may be very simple in nature: for example, one of the test sheets may have a certain mark, such as a small square in a predetermined position, and the other will not have the mark.

The outputting of test sheets can be initiated by a computer 16 external to a target printer or copier, at the user interface of the copier or printer, or can be self-initiated by the copier or printer, such as to occur on a periodic basis or at power-up. Once the test sheets are output from a printer or copier, the sheets are fed into a scanner, either stand-alone scanner 14 or a scanner associated with one of the digital copiers 12, as shown by the arrows in FIG. 1. In this embodiment, a scanner which is suitably associated with software for carrying out the method is capable of performing steps relevant to the calibration for any printing apparatus to which it has ultimate access. In other words, because each test sheet includes an identification of the printer which outputted it, a network connection can be made, either directly from the copier or scanner, or via a computer 16, to the target printer which is desired to be calibrated. In the case of a digital copier, where the same machine both outputs the test sheets and scans them, this network identification can be circumvented, or provision can be made for the copier to access itself through its own network address. Further, it is possible, with the embodiment, to load into a scanner test sheets from a number of target printers at once, even if test sheets from different printers happened to be shuffled together in the process: downstream software associates each individual test sheet with the printer which outputted it.

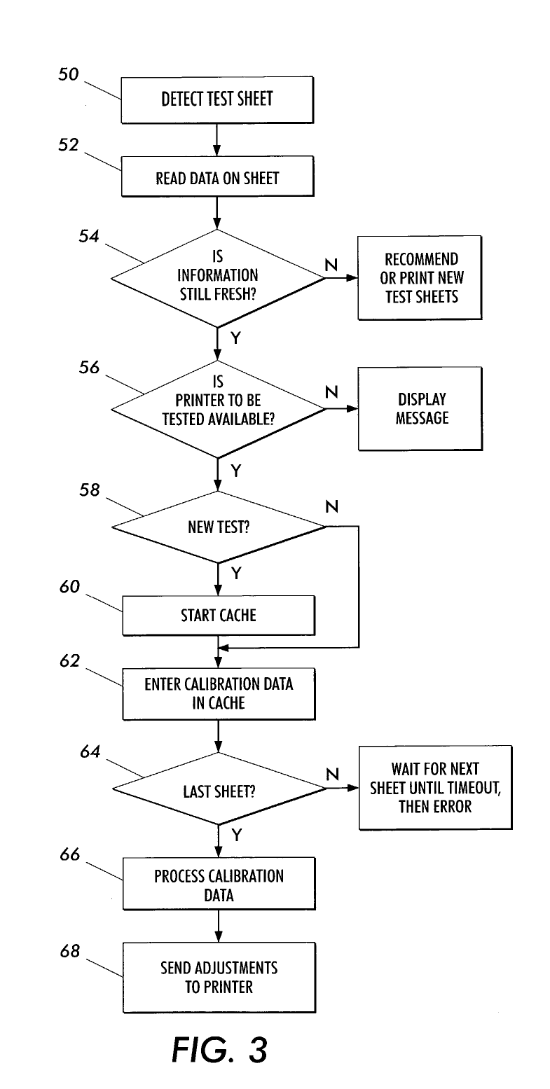

FIG. 3 is a flow-chart of steps that are carried out by software associated with a scanner 14 or scanner portion of a digital copier 12, according to one embodiment. The illustrated method is designed to react to one detected test sheet (of a plurality of test sheets forming a set for a calibration operation) at a time, and to be directed to one printer over a network; different parts of the method can be carried out at the scanner, at a computer 16, or at the printer 10. A calibration operation can be initiated simply by loading test sheets into the scanner, where the sheets can be recognized by an image-recognition capability associated with the scanner, or by entry of data into a user interface associated with the scanner (step 50). Once a sheet fed through a scanner or copier is identified as a test sheet for calibration, software at the scanner records the metadata, as well as the patch data, on the sheet (step 52).

In any calibration process, the “freshness” of the test data is important: there is no point in considering test patches which are of more than a certain predetermined age (such as one day), because the printer to be calibrated will have drifted in performance between the time of outputting the test patch and the calibration operation. Therefore, the software must check the time of test sheet output, as read from the test sheet itself, with the current time, to make sure the test patches are still fresh (step 54). If the test patches are deemed too old and therefore not fresh, an error message can be displayed, either at the scanner/copier, the printer being tested (such as by causing the printer to output a sheet bearing an error message), and/or at a control computer. Also, if a submitted test sheet is determined to be not fresh, a system can automatically cause the printer identified on the sheet to output a new set of test sheets, or at the least display to a user a recommendation that a new set be output.

Another preliminary check is to determine whether the printer identified on the test sheet is in fact accessible to be calibrated (step 56). A digital copier or associated computer such as 16 must have such access to the printer in order to send calibration information and instructions to it. There are many ways to check for accessibility: the computer 16 may retain a list, which can be readily cross-checked, of printers to which it has administrator-level access; or a test message or ping could be sent to the printer's network address. If the printer to be calibrated proves totally or temporarily inaccessible, an error message can be generated and presented to a user in some way.

As mentioned above, the illustrated embodiment reacts to each test sheet in a multi-sheet calibration operation individually, so that sheets for an operation can be fed in any order, and sheets for operations on different printers can be shuffled together. To do this, the system must temporarily retain the patch data and metadata for partial sets of test sheets until all of the test sheets for a calibration operation are fed. As shown in steps 58-64, when the system detects a first sheet of a requested calibration, the system opens an account, or cache, of the data, which will hold the patch data until all of the other test sheets for the operation are identified and retained. If a subsequent test sheet belongs to a set of test sheets for which an account or cache has been started, the patch data from that sheet is added to the cache. (An alternate technique is to have the software “expect” a number of sheets, possibly with each sheet being identified by mode.) When it is determined that all of the necessary test sheets to calibrate a printer have been retained, the method can continue. If a predetermined time elapses after an account has been opened and all of the necessary test sheets have not been detected, an error message is generated. The account or cache, as well as the software to create and maintain it, can be resident in whole or in part at the scanner, computer, or printer.

Once all of the necessary test sheets have been cached, the patch data from the test sheets is processed (step 66), basically by comparing the recorded color measurements with the color data that had been submitted to the printer when outputting the test sheets; after processing of the test data, instructions are sent to the printer being calibrated (step 68), ultimately to correct for errors discovered in the calibration process or to make other adjustments as desired. Various specific processing and calibration methods are discussed in the patents cited above, and those or variations thereof may be practiced, with the processing occurring in whole or in part on computers local to the scanner or digital copier, an independent computer or server resident on the network, or at the printer itself. Typically, all that will be sent to the printer being calibrated will be the metadata and the color measurement data from the reading of the test patches, and not the actual data from reading the test sheets. As used herein, any kind of data which is derived from the reading of a test image and ultimately used to alter or adjust a behavior of a printer receiving the data is called “calibration data.”

In a typical scenario, a printer receiving color measurement data and to thereby performing calibration steps for itself can in turn output a set of test images, such as of the same color photograph or test pattern, using the original, pre-calibration rendering parameters, the parameters resulting from the recent calibration, and perhaps a pre-set baseline calibration. A human user can then select which set of parameters yields the images most pleasing to him.

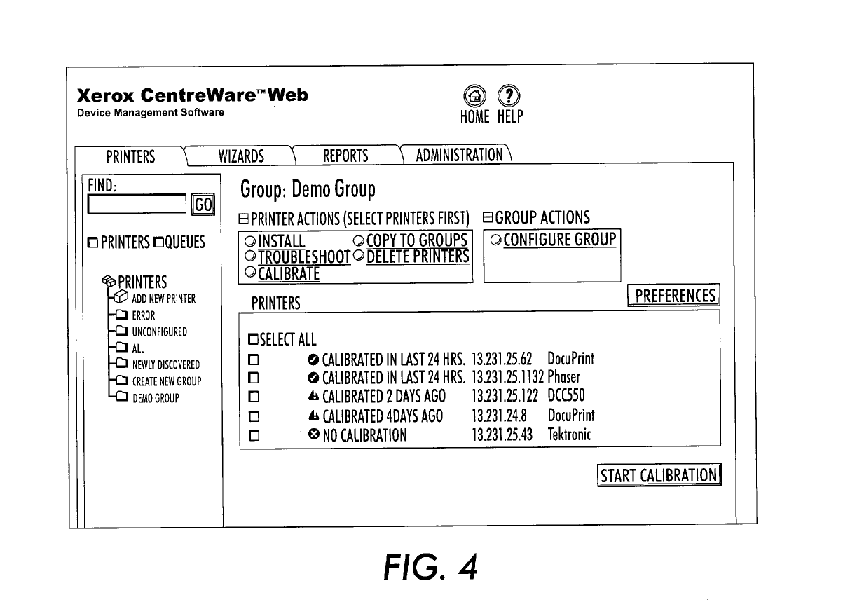

If it is desired to perform calibration on a fleet of printers and copiers, a network utility can be provided. FIG. 4 is an example screen as would appear in a network utility for calibrating a plurality of printers on a network, such as running on a computer 16.

The network utility identifies all of the suitably enabled machines on that network for both being calibrated as well as which machines, such as copiers, are suitable for submission of test images thereto. Through a network utility, a systems administrator can initiate a “discovery,” such as including a ping sweep, of all the printers or other machines available on the network. Relevant information about the discovered machines are then displayed; for example, does the machine need to be calibrated, how long ago was the last calibration performed, etc. The information about the last time a machine was calibrated can be retained locally at each machine and retrieved at discovery or as needed; or can be retained in a memory associated directly with the network utility. As shown in FIG. 4, next to information about each machine can be displayed a symbol indicating the urgency of calibration of the machine relative to a predetermined policy or criterion; alternately, in the case of a large fleet of machines, the network utility can be designed to display information only about those machines deemed to be in need of calibration. The utility can also provide pop-up messages (not shown) advising that a calibration operation may be desirable at a certain time.

Through the utility the user launches the calibration sequence for any number of the machines, such as by designating the machines to be calibrated, and, in the example of FIG. 4, hitting a “Start calibration” button to cause all the machines to be calibrated to output test sheets at essentially the same time. The user then collects the test sheets from all the machines, and loads all of the test sheets into the document handler of one scanner or copier on the network. The network utility can also indicate which machines on the network, such as digital copiers, can be used as color measuring devices, or can associate with each displayed machine (such as by touching the name of the machine with the cursor, not shown) which color measuring device is closest to or most suitable for accepting test sheets from the machine. The calibration of each machine which results from the loading and recording of the test sheets can be monitored and displayed by the network utility as well; for instance, the network utility can display when each printer is successfully calibrated, such as to update the “last calibrated at (time)” entry for that printer or indicate that a certain time has elapsed and not all of the necessary or desirable test sheets for the calibration have been submitted to the system. Also, the network utility can monitor instances where the test sheets from a printer are so far from the desired image data that a problem with the printer beyond the scope of calibration may be occurring: when that occurs, a service call or electronic mail message can be recommended or automatically placed for the printer.

1. A method of calibrating a digital printer, comprising:
causing the digital printer to output a plurality of test sheets, each sheet bearing a subset of test images and metadata identifying the subset of test images relative to a set of test images used for a calibration operation.

2. The method of claim 1, further comprising
submitting the plurality of test sheets to a color measurement device to yield calibration data.

3. The method of claim 2, wherein the submitting includes feeding the plurality of test sheets through a document handler.

4. The method of claim 1, further comprising
using the calibration data to alter a behavior of the digital printer.

5. The method of claim 1, the metadata further including a code identifying a time of outputting.

6. The method of claim 5, further comprising
submitting the plurality of test sheets to an input scanner to yield calibration data; and
determining that a test sheet is fresh.

7. The method of claim 1, the metadata further including data identifying the digital printer.

8. The method of claim 7, further comprising
determining that the digital printer is accessible for calibration.

9. The method of claim 1, wherein the metadata identifies a mode to be calibrated for.

10. The method of claim 1, further comprising
submitting the plurality of test sheets to an input scanner to yield calibration data; and
determining that a sufficient number of test sheets have been submitted to the scanner.

11. A method of calibrating a plurality of digital printers, comprising:
obtaining from each of the plurality of digital printers information about when the digital printer was last calibrated;
causing a selected subset of the plurality of digital printers to output a sheet bearing a test image.

12. The method of claim 11, further comprising
discovering the plurality of digital printers on a network.

13. The method of claim 11, further comprising
displaying information about each of the plurality of digital printers.

14. The method of claim 11, further comprising
displaying information about only each of the plurality of digital printers which are deemed to be advisable for calibration.

15. The method of claim 11, further comprising
displaying, for each of the plurality of digital printers, information about a suitable measuring device.
